(19) United States
(12) Patent Application Publication
(10) Pub. No.: US 2005/0221144 A1
(43) Pub. Date: Oct. 6, 2005

(54) Fuel cell apparatus

(75) Inventor: Shinichi Takahashi, Kanagawa (JP)

Correspondence Address: MCDERMOTT, WILL & EMERY, 600 13th Street, N.W., Washington, DC, 20005-3096, US

(73) Assignee: NISSAN TECHNICAL CENTER N.A. INC.

(21) Appl. No.: 10/811,899

(22) Filed: Mar. 30, 2004

(51) Int. Cl. H01M 2/00; H01M 2/02; H01M 2/14

(52) U.S. Cl. 429/34; 429/39

(57) ABSTRACT

A fuel cell is disclosed having a water channel and a polymeric material contained in the water channel which minimizes freezing of water in the channel at sub-zero temperatures. Embodiments including attaching a thermo-responsive polymer such as an N-isopropyl acrylamide to the surface of the water channel to cause the thermo-responsive polymer to expand at low temperatures thereby reducing the propensity for water to freeze in the channel and also to cause the thermo-responsive polymer to contract at higher temperatures thereby preventing any restriction in the flow of circulating water in the channel.

### FIELD OF THE INVENTION

The present invention generally relates to fuel cells, and more particularly to improvements in the performance of polymer fuel cells having a water channel.

### BACKGROUND OF THE INVENTION

In a fuel cell that contains a pure water channel, the water in the pure water channel freezes at temperatures of 0° C. and below. Consequently, if the fuel cell is in an environment of 0° C. or below, the pure water channel may be blocked, and the fuel and air passages may also be clogged due to frozen water. If a fuel cell is started up in a frozen state, it may take a long time to reach the rated output, since it is necessary to melt the accumulated ice. Alternatively, the interior of the fuel cell stack, which includes the polymer membrane, may be damaged, thereby worsening cell performance.

One method of solving this problem is to discharge the pure water from the channel outside of the cell when the fuel cell is shut down. The water can be discharged by gravity, or by using a pump. For instance, in Patent Disclosure Heisei 11-273704, a fuel cell is equipped with a means of drainage. After cell operation is completed, the means of drainage comes into effect, and the water accumulated in the fixed polymer fuel cell, tank, supply means, and discharge means is discharged to the outside. Thus, even when the fuel cell equipment is operated outside in a cold climate and is subsequently shut down, there is no frozen water inside the fuel cell, and consequently the pure water channel is not blocked due to freezing when the fuel cell is restarted.

If the pure water channel has a humidifying or cooling function, it cannot perform these functions when the fuel cell is started up, since there is no pure water in the channel after discharge. Therefore, when the fuel cell is restarted, it is necessary to re-supply the water channel with pure water, because recirculated water alone is not enough. In addition, discharging a large quantity of water from the fuel cell has other disadvantages. For instance, given a fuel cell for automotive use, there is the risk of causing the road to ice over if a large quantity of pure water is discharged to the outside environment at sub-zero temperatures. For this reason, others have employed a reservoir tank outside of the fuel cell, and storing pure water in the reservoir tank while the fuel cell is shut down. However, since the pure water in the reservoir tank also freezes, it is necessary to melt the ice in the reservoir tank when re-starting. This lengthens the time required for startup, and increases the fuel consumption due to the utilization of a heater.

Once a fuel cell is being operated, it can run smoothly at an optimum temperature and efficiency. At startup, however, the cell requires a certain temperature, which is typically above the freezing point of the water contained therein to run efficiently. Hence, there is a continuing need for the efficient operation of fuel cells have water channels.

### SUMMARY OF THE INVENTION

An advantage of the present invention is an improved fuel cell having a water channel which minimizes the potential for water freezing in the channel.

These and other advantages are satisfied at least in part by a fuel cell having a water channel which contains a polymeric material attached to the walls of the channel. In an embodiment of the present invention, the fuel cell is characterized by having a pure water channel comprising polymers, wherein one end of the polymer chains are connected to a surface of the channel and said chains are capable of forming an entanglement among themselves. Advantageously, such a structure permits water contained in the channel to be bound by the polymer material through polymeric entanglements thereby minimizing the potential for the water to freeze when the cell is not in operation. When the cell is operated, the flow of water and/or the increase in temperature of the cell causes the polymeric material to disentangle thereby allowing water to flow through the channel during normal operation.

The fuel cell can further comprise a means for discharging excess water from the channel to outside of the cell when the cell is shut down and means for measuring at least the flow rate or at least the pressure of the water in the channel and a means for controlling the flow rate or pressure of the water in the channel so that it does not exceed a predetermined range.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The various features and advantages of the present invention will become more apparent and facilitated by reference to the accompanying drawings, submitted for purposes of illustration and not to limit the scope of the invention, where the same numerals represent like structure and wherein:

FIG. 1 illustrates representative idealized polymer chain structure in a pure water channel of a fuel cell when it is shut down in accordance with one embodiment of the present invention;

FIG. 2 shows a fuel cell in accordance with one aspect of the present invention;

FIG. 3 illustrates a fuel cell in accordance with another embodiment of the present invention;

FIG. 4 is a flow diagram showing the process flow of a coolant system upon starting up a fuel cell system in accordance with an embodiment of the present invention;

FIG. 5 illustrates a flow diagram showing the process flow of a coolant system upon shutting down a fuel cell system in accordance with an embodiment of the present invention;

FIG. 6 illustrates a graph showing the history of a fuel cell stack's operating temperature in accordance with one aspect of the present invention.

### DESCRIPTION OF THE INVENTION

The present invention is directed to a polymer fuel cell and its operation which comprises at least one water channel to feed or remove water from the fuel cell. In accordance with the present invention, the water channel has a polymeric material contained therein to reduce or minimize the potential freezing of any water in the channel. The polymer fuel cell further comprises an electrolyte membrane sandwiched between an anode electrode and a cathode electrode. The fuel cell can have a plurality of such membrane cells to form a fuel cell stack. The fuel cell stack can also have a plurality of water channels each having a polymeric material contained therein to minimize potential freezing of water.

The water channels are typically associated with the anode side electrode and provide water vapor to the cell and transport byproducts and other components from the cell. These channels can contain pure water and/or other components. Hence, the terms water channels and pure water channels are used herein interchangeably.

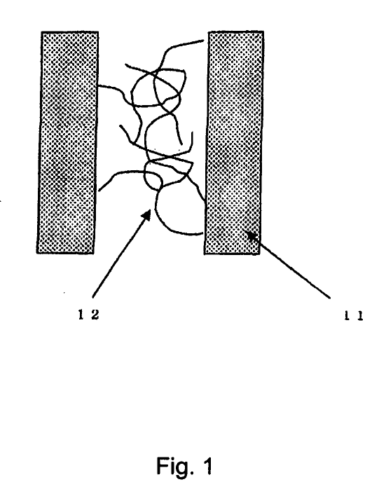

In an embodiment of the present invention, the structure of the pure water channel having the polymeric material is such that one end of the polymer chain is connected to the surface of the pure water channel (10), as shown in FIG. 1. Such polymer chains can form an entanglement (12) when the environmental temperature is low or when the flow of water ceases. Within the polymer entanglements, there are water molecules that undergo binding (bound water) due to the interaction with the polymer chains. Water classified as “bound water” does not readily freeze, at or below 0° C., due to polymer-water interactions. In addition, due to the action of polymers (as well as other components) in lowering the freezing point, water contained within the polymer entanglement does not readily freeze, even at or below 0° C. Consequently, even when a fuel cell is used in an environment below 0° C., it is not necessary to discharge the pure water outside of the fuel cell beforehand to prevent freezing, or to use a reservoir tank to discharge the pure water. Advantageously, when the fuel cell is re-started, it can begin to operate immediately, without re-supplying water to the channel after the cell is stopped.

Connecting or attaching polymer chains to a pure water channel surface can be carried out by the general method of surface treating the contemplated surface to which the polymeric material is to be attached followed by polymerization of monomers or attachment of already formed materials. For instance, polymer chains are be connected to the surface of a pure water channel by applying a plasma treatment to the channel surface and connecting the polymer chain at the active site, or by forming a polymer membrane layer on the channel surface beforehand and causing a portion of the membrane layer to react with the polymer chain.

Advantageously, the structure of the fuel cell is such that the flow of pure water in the water channel is ceased when the fuel cell is shut down. The polymeric material in the channel can then spread out and occupy more of the channel. When the cell is operated, however, the polymeric material occupies less channel volume. This can occur simply due to the natural tendency of the polymeric material (when some part is attached to the surface of the channel) to self associate (i.e., form entanglements) when there is no flowing water versus orienting along the flow direction when the cell is in operation, thereby ensuring the necessary flow rate of water for the operation of fuel cell. By using polymeric materials having weak entanglements among polymer chains, it is possible to form and break up the entanglements in accordance with the flow of water in the channel.

For example, polymeric materials having hydrophilic chains will spread out in water at reduced temperatures. While the fuel cell is in operation, i.e., at elevated temperatures, the polymer chains do not obstruct the flow of pure water, because the chains spread out in the direction in which the water flows.

In an embodiment of the present invention, the polymeric material attached to the water channel comprises an alkyl base. The polymer can have a principal chain which is a continuous structure having an alkyl base or it can be a copolymer whose principal chain structure is an alkyl base. Although an alkyl based polymer is preferred in this embodiment of the present invention, the polymeric material is not limited thereto. It is preferred that the polymer have enough flexibility so that entanglements can easily form in the water channel and can be easily disentangled by the flow of water in the channel.

Thermo-responsive polymers are also contemplated in the present invention. Thermo-responsive polymers can undergo volume phase transition in accordance with the temperature of the pure water that contain such polymers. For example, if the temperature of the pure water becomes high, as when the fuel cell is in operation, the polymer entanglements contract as they undergo a volume phase transition, thereby permitting the flow of pure water. In addition, when the temperature of the pure water falls, such as after the fuel cell is shut down, the polymer spreads out in the pure water, and the chains tend to form a weakly connected network. Since this network retains pure water within itself, the pure water does not readily freeze, even below its normal freezing point.

Any thermo-responsive polymer can be used in the present invention. Thermo-responsive polymers that contracts in water at temperatures of about 40° C. or higher, and expands in water at temperatures of about 20° C. or lower are preferred. These polymers do not block the flow of pure water when applied in a polymeric solid electrolyte fuel cell, within the preferred working temperature ranges of the fuel cell. In an embodiment of the present invention, the polymer chain comprises N-isopropyl acrylamide, or an N-isopropyl acrylamide co-polymer. These materials do not block the flow of pure water when applied in a polymeric solid electrolyte fuel cell, within the working temperature range of the fuel cell.

Although the use of a polymeric material in the water channel can reduce the potential of water freezing therein, which thereby reduces the need to discharge water from the channel, the present invention also contemplates the use of an external reservoir and connections thereto for the discharge of water from channels. Since the fuel cell has a means of discharging the water in the pure water channel to outside of the fuel cell when the fuel cell is shut down, it can further prevent the pure water from freezing in the cell. This structure is suitable, for example, when the sectional area of the pure water channel is so large that the polymer chain entanglement cannot retain all of the pure water, but is not limited thereto.

Discharging excess water from the cell can be by means of gravity or by employing a pump or by any other equivalent means. Since it is preferable that the polymer entanglement retain enough water that is needed when the fuel cell is re-started, it is sufficient if the quantity of pure water discharged to the outside is roughly the quantity that the polymer entanglement cannot retain. In addition, if a pump is used to discharge pure water to the outside, it is sufficient if the quantity of pure water discharged is approximately the quantity that the polymer entanglement cannot retain. Discharging approximately the quantity of water not needed upon startup advantageously reduces the energy consumption of the system.

Since the fuel cell system has a means of measuring at least one of either the flow rate of pure water flowing through the pure water channel of the fuel cell system or the pressure of the pure water, and since it has a means of control either the flow rate or the pressure of the water, the polymer chains connected to the surface of the pure water channel in the fuel cell are protected from being removed. The flow rate and pressure can be a predetermined level or range.

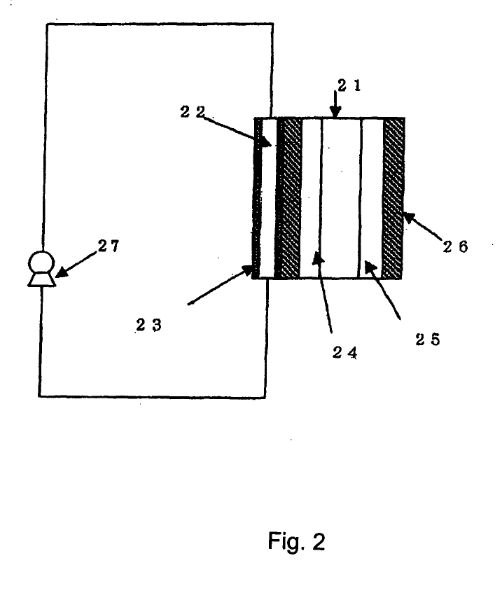

In another embodiment of the present invention, FIG. 2 illustrates an example of a fuel cell structure. Fuel gas passage 24 and air passage 25 are provided, one on each side of membrane electrode structure 21. Electrode structure 21 can comprise a polymer electrode membrane sandwiched between an anode electrode and a cathode electrode (not shown for illustrative convenience). Pure water channel 22 encloses porous separator 26, and is partitioned by fuel gas passage 24 and air passage 25. Pure water in pure water channel 22 is circulated by pump 27. Pure water flowing in pure water channel 22 passes through porous separator 26, and humidifies the fuel gas passing through fuel gas passage 24 and the air passing through air passage 25. As an example of a polymeric material contained within a water channel, one end of polymethyl methacrylate (PMMA) is connected to the surface of pure water channel 22, and forms PMMA molecular layer 23. In the PMMA molecular layer 23, PMMA molecules are connected perpendicular to pure water channel 22. PMMA molecular layer 23 can be formed using the general method of surface treatment for attaching polymers. For example, plasma treatment can be performed on separator 26, and subsequently methyl methacrylate monomer can be polymerized to attach PMMA chains on pure water channel 22 only, so that PMMA molecular layer 23 is formed. When the fuel cell is shut down, pump 27 stops, so that pure water does not circulate. In this example, the PMMA molecules of the PMMA molecular layer spread out in pure water channel 22, and form entanglement with other PMMA molecules.

When the atmospheric temperature surrounding a fuel cell structured as shown in FIG. 2 was lowered to −10° C., and the system was left for 8 hours, and dried hydrogen gas and air were then caused to flow, the fuel cell started to generate electricity again. At the same time, circulation of pure water was started by operating pump 27, and since the pure water had not frozen, it was immediately able to circulate. Subsequently, the fuel cell operated normally at about 70° C.

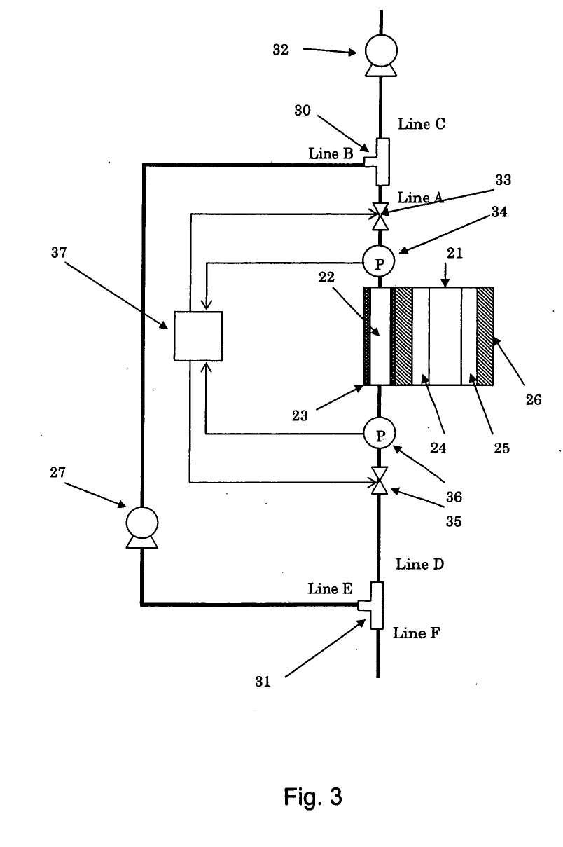

In another embodiment of the present invention, FIG. 3 illustrates an example of a fuel cell structure. The structure shown in FIG. 3 is similar to FIG. 2 except that FIG. 3 illustrates a means for draining a water channel outside of the cell and outside of the system. As shown in FIG. 3, fuel gas passage 24 and air passage 25 are provided on either side of membrane electrode 21. Pure water channel 22 encloses porous separator 26 and is partitioned by fuel gas passage 24 and air passage 25. Pure water channel includes polymer layer 23 which is attached to the inner surface of the channel. Blower 27 is connected to pure water channel 22 through lines A, B, E, and D. Pure water can be made to circulate through the cell by actuating blower 27 and three-way valves 30 and 31. Water can be drained from the cell by actuating three-way valves 30 and 31 and blower 32.

Also included in the circulating water loop are pressure gauges 34 and 36 which feed a signal to pressure controller 37 which in turn controls pressure controlled values 33 and 35. As is known in the art, a computer or microprocessor can be used to control three-way valves 30 and 31 as well as pressure controller 37 and control valves 33 and 35. The apparatus shown in FIG. 3 permits recycling of pure water while the cell is functioning during a normal electricity generation mode. When the cell is shut down, this apparatus can be operated such that water is drained from the cell as needed to remove excess water in the water channel that is not bound by polymer layer 23.

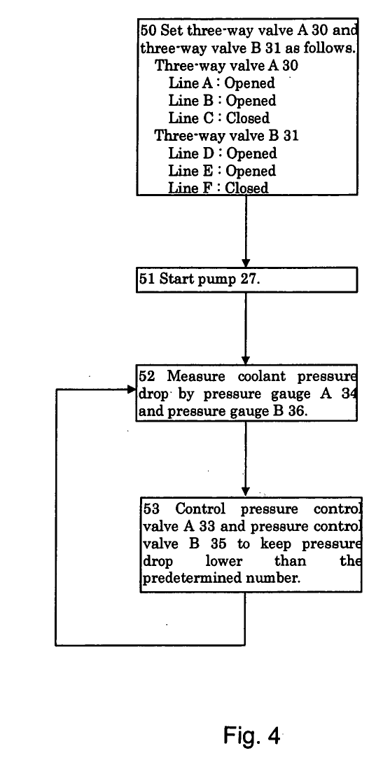

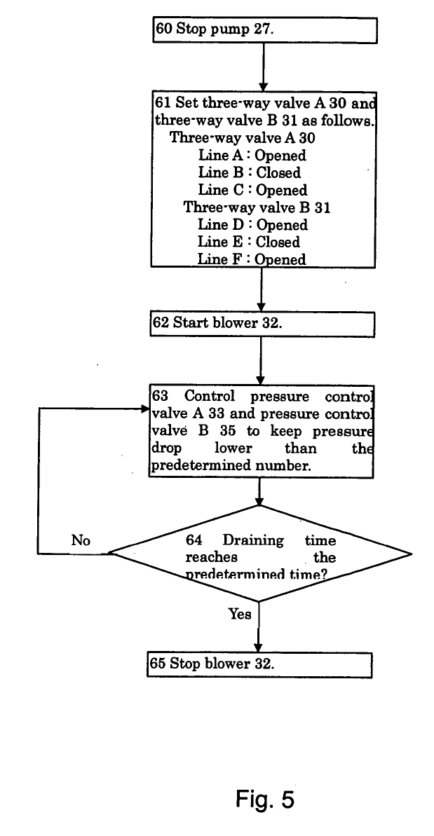

The operation of a fuel cell with a water channel will be provided with reference to the flow diagrams of FIGS. 4 and 5 and with reference to the apparatus shown in FIG. 3. As is understood by those skill in the art, this operation can be computer controlled for optimum results in operation.

As seen in FIG. 4, start-up operation begins at 50. During startup, three-way valve 30, as shown in FIG. 3, allows water to flow through lines A and B. Line C is closed. Three-way valve 31, shown in FIG. 3, allows water to flow through lines D and E and closes line F. At step 51, pump 27 is turned on which permits water to circulate through the cell. At step 52, the pressure drop in the circulating water is measured by pressure gauge 34 and 36. The pressure measurements are inputted to controller 37. At step 53, pressure control valves 33 and 35, are operated by controller 37 to maintain a predetermined pressure in the circulating flow of water circulating through the cell.

FIG. 5 is a flow diagram illustrating the operations of the fuel cell of FIG. 3 during a shut down operation. As seen in FIG. 5, shut down begins at step 60 with the stopping of pump 27. At step 61, three-way valve 30 is set so that line A and line C are opened and line B is closed. Three-way valve 31 is set so that lines D and F are open and line E is closed. At step 62, blower 32 is operated. At step 63, the pressure in the water channel is monitored by pressure gauges 34 and 36 which sends a signal to controller 37 which in turn operates control valves 33 and 35 to ensure a predetermined pressure range. At step 64, a decision is made whether enough time has elapsed. The elapsed time can be preset and can depend on such factors as the volume of water in the water channel, the amount of polymer contained in the water channel, the amount of water necessary to operate the cell at start up, the outside temperature, etc. all of which can be empirically predetermined. If the drainage time has not elapsed, the system returns to step 64. If the time has elapsed, the system goes to step 65 which halts blower 32.

Reference is now made to the following examples for illustrative purposes.

### EXAMPLE 1

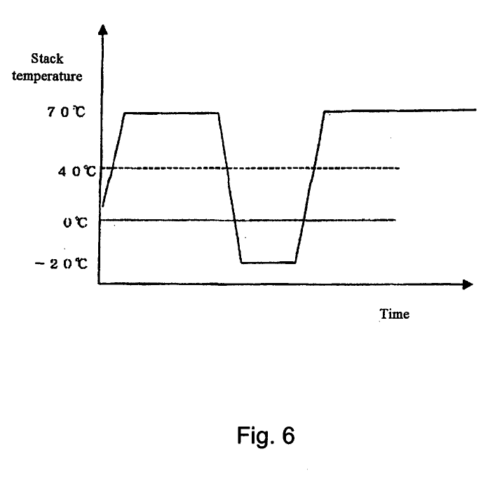

In this example, a fuel cell stack having cells with a basic structure shown in FIG. 2 was used. The cells differ in that one end of N-isopropyl acrylamide is connected to the surface of the pure water channel rather than PMMA. The N-isopropyl acrylamide was attached to the channel wall by plasma polymerization. This fuel cell stack was operated by the procedure shown in FIG. 6. After startup at room temperature, the cell is operated at about 70° C., and is subsequently shut down. After shutdown, the atmospheric temperature surrounding the fuel cell is lowered to −20° C. The N-isopropyl acrylamide undergoes volume phase transition at about 40° C., and expands in the pure water channel. After maintaining the cell for 8 hours at −20° C., dried hydrogen gas and air at 40° C. were caused to flow, which caused the cell to start generating electricity again. At the stage where the fuel cell temperature reaches 40° C., pure water starts to circulate. Due to the rise in fuel cell temperature, the N-isopropyl acrylamide contracts in the pure water channel. Due to the contraction of the N-isopropyl acrylamide, the flow rate of pure water in the pure water channel is established at the rate necessary for normal operation. Subsequently, the fuel cell stack temperature reaches 70° C., and normal operation comes into effect, without a noticeable voltage drop.

### EXAMPLE 2

In this example, a fuel cell having the basic cell structure as shown in FIG. 3 was used. In addition to the implementation of example 1, three-way valve 30, three-way valve 31 and blower 32 are set in the coolant loop. Pressure gauge 34 and pressure gauge 36 are set to control pressure control valve 33 and pressure control valve 35 through pressure controller 37. During operating the fuel cell system, three-way vale 30 and three-way valve 31 are set as follows to make a loop.

| Three-way valve 30 | Three-way valve 31 |
|---|---|
| Line A: Opened | Line D: Opened |
| Line B: Opened | Line E: Opened |
| Line C: Closed | Line F: Closed |

First, three-way vale 30 and three-way valve 31 are set as follows to drain water from the fuel cell stack when the fuel cell system is shut down.

| Three-way valve 30 | Three-way valve 31 |
|---|---|
| Line A: Opened | Line D: Opened |
| Line B: Closed | Line E: Closed |
| Line C: Opened | Line F: Opened |

Secondly, blower 32 starts to drain water from fuel cell stack. Blower 32 stops after a predetermined time period.

During operating a fuel cell system and draining water from a fuel cell stack, pressure controller 37 controls pressure control valve 33 and pressure control valve 35 to keep the pressure drop of the coolant channel inside the fuel cell stack under a predetermined pressure.

Only the preferred embodiment of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific procedures and arrangements described herein. Such equivalents are considered to be within the scope of this invention, and are covered by the following claims.

1. A fuel cell characterized by having a pure water channel comprising polymers, wherein one end of the polymer chains are connected to a surface of said pure water channel, and said polymer chains can form an entanglement among themselves.

2. The fuel cell of claim 1 is characterized by a structure that the flow of pure water in the said pure water channel is stopped when the fuel cell is shut down, and pure water flows in the said pure water channel when the said fuel cell is operated, and the said polymer entanglement is broken up by the flow of pure water.

3. The fuel cell of claims 1 or 2 wherein said polymer chain is hydrophilic.

4. The fuel cell of claim 3 wherein said polymer chain has a principal chain that is a continuous alkyl base, or a co-polymer whose principal chain is a continuous alkyl base.

5. The fuel cell of claim 1 wherein said polymers are a thermo-responsive and undergo a volume phase transition in accordance with the temperature of the pure water.

6. The fuel cell of claim 5 wherein said thermo-responsive polymers contract in water at temperatures of 40° C. or higher, and expand in water at temperatures of 20° C. or lower.

7. The fuel cell of claim 6 wherein said polymer chain is N-isopropyl acrylamide, or an N-isopropyl acrylamide co-polymer.

8. A fuel cell characterized by having a pure water channel and a means for discharging the water in the pure water channel to outside of the fuel cell when the fuel cell is shut down.

9. The fuel cell of claim 8 further characterized by means for measuring at least one of either the flow rate of pure water flowing through the pure water channel of the fuel cell system or the pressure of the pure water, and means for controlling said at least one of either the flow rate of the said pure water or the pressure of the said pure water to a level that does not exceed a predetermined range.

10. A method of operating a fuel cell having a water channel with a polymeric material contained therein, the method comprising:
permitting water to flow through the channel when operating the cell; and
holding water in the polymeric material when the cell is not operating.
